(19) United States
(12) Patent Application Publication
(10) Pub. No.: US 2026/0264262 A1
(43) Pub. Date: Sep. 10, 2026

(54) TORQUE CONTROL AND FEEDBACK FOR THERMAL AUTOSAMPLER ACTUATOR MECHANISM

(71) Applicant: TA Instruments-Waters LLC, New Castle, DE (US)

(72) Inventors: James Goss Ferneyhough, Newark, DE (US); Christopher Ubelacker, West Chester, PA (US); Scott Merrullo, Newark, DE (US)

(21) Appl. No.: 19/451,395

(22) Filed: Jan. 16, 2026

Related U.S. Application Data
(60) Provisional application No. 63/746,105, filed on Jan. 16, 2025.

(51) Int. Cl. B25J 13/08; G01N 35/00

(52) U.S. Cl. CPC B25J 13/085; B25J 13/088; G01N 35/0099

(57) ABSTRACT

A torque control mechanism for an end effector of an autosampler includes a coupler input member configured to receive a motor shaft that includes a stop member, a coupler output member defining an interior region to receive the coupler input member including a stop engagement protrusion extending into the interior region, and a torsion spring having a first end coupled to the coupler input member and a second end coupled to the coupler output member. The stop member and the stop engagement protrusion are arranged to permit relative rotation between the coupler input member and the coupler output member in a first direction corresponding to gripper closing. A controller is configured to determine a coupler deflection based on a difference between an angular position of the motor shaft and an angular position of a gripper mechanism coupled to the coupler output member and control torque using the determination.

### RELATED APPLICATION

This application claims priority to U.S. Provisional Patent Application No. 63/746,105 filed on Jan. 16, 2025 and titled “Torque Control and Feedback for Thermal Autosampler Actuator Mechanism” then entirety of which is incorporated herein by reference.

### FIELD OF THE INVENTION

The disclosed technology generally relates to robotic end effector actuation. More particularly, the disclosed technology relates to a coil torsion spring coupler between a stepper motor and end effector allowing for torque feedback and control

### BACKGROUND

A thermal autosampler can include a robotic device that automatically loads sample and reference pans to and from a measurement cell or the like. The robotic device typically includes an end effector having an actuator mechanism attached to the end of the robot's arm. One type of end effector has mechanical gripper fingers at the end of a robotic arm or on a cartesian robot for grasping pans or the like. A stepper motor provides precise position control and high torque at low speeds by receiving pulses that are converted to mechanical motion. A motor driver generates and counts the pulses for providing the position control. Stepper motors are a low cost actuator with easy position holding capabilities.

A stepper motor directly driving an end effector allows for straightforward position control. However, unlike DC motors where torque is proportional to current, stepper motors have no intrinsic means of monitoring or controlling output torque. This limits their use in applications requiring torque measurement and control. In many applications, grip strength (proportional to torque) is the key parameter in determining security of grip, not gripper position.

Systems only capable of position control generate grip force by driving the gripper position some distance beyond the position where the gripper contacts the gripped object. This generates a grip force based on the overall stiffness of the load chain (including the gripped object). If the overall load chain is stiff, small errors in position (due to object size variation, variation in gripper geometry, etc.) can result in large errors in grip force. This can lead to decreased grip security due to low force (in some cases, failing to grab the object all together) or damage to the gripper mechanism or gripped object due to excess force. Torque gauges can be installed in the load chain with a stepper motor to measure torque, but control accuracy and resolution is then determined by the overall stiffness of the actuator and mechanism. If mechanism stiffness is high and/or unpredictable, torque control resolution will correspondingly be low and/or unpredictable.

Additionally, if a gripper is intended to be used with different types of objects of different sizes, the system must know the appropriate position to place the gripper for each object, requiring multiple calibrations or other means of acquiring said information.

### SUMMARY

In one aspect, a torque control mechanism for a robotic end effector of an analytical instrument autosampler is provided. The torque control mechanism includes a coupler input member configured to receive a motor shaft, the coupler input member including a stop member. The torque control mechanism includes a coupler output member defining an interior region sized to receive the coupler input member, the coupler output member including at least one stop engagement protrusion extending into the interior region. The torque control mechanism includes a torsion spring disposed between the coupler input member and the coupler output member, the torsion spring having a first end coupled to the coupler input member and a second end coupled to the coupler output member. The stop member and the at least one stop engagement protrusion are arranged to permit relative rotation between the coupler input member and the coupler output member in a first rotational direction corresponding to gripper closing while preventing relative rotation in a second rotational direction corresponding to gripper opening. A controller is configured to determine a coupler deflection based on a difference between an angular position of the motor shaft and an angular position of a gripper mechanism coupled to the coupler output member, and to calculate an output torque applied to the gripper mechanism based on the coupler deflection and a torsional stiffness of the torsion spring.

Additionally or alternatively, the torque control mechanism further includes a first encoder configured to measure the angular position of the motor shaft, and a second encoder configured to measure the angular position of the gripper mechanism coupled to the coupler output member.

Additionally or alternatively, the controller is configured to calculate the output torque according to a relationship where the output torque equals the torsional stiffness multiplied by the coupler deflection plus a preload torque value.

Additionally or alternatively, the stop member comprises a tab extending from the coupler input member, and the at least one stop engagement protrusion includes a preload adjustment screw configured to establish an initial angular position of the stop member relative to the coupler output member in a preload condition.

Additionally or alternatively, in a preload condition the torsion spring biases the stop member into contact with the at least one stop engagement protrusion such that the coupler input member and the coupler output member rotate together as a unit.

Additionally or alternatively, the controller is configured to operate in a position control mode when the stop member is engaged with the at least one stop engagement protrusion and to operate in a torque control mode when the stop member is disengaged from the at least one stop engagement protrusion.

Additionally or alternatively, the arrangement of the stop member and the at least one stop engagement protrusion enables the controller to apply negative torque through the coupler output member to overcome friction in the gripper mechanism during gripper opening by rigid coupling through the engaged stop member.

Additionally or alternatively, the torsion spring comprises a coil torsion spring having a near linear relationship between torque applied to the torsion spring and deflection of the torsion spring.

Additionally or alternatively, the coupler input member includes two stop members extending in opposite directions from a cylindrical coupler input, and the coupler output member includes two stop engagement protrusions extending into the interior region.

Additionally or alternatively, the controller is configured to modulate the output torque by controlling an angular position of the motor shaft and using the coupler deflection as feedback to achieve a target torque value.

In another aspect, a method for position and torque control of an autosampler is provided. The method includes providing a torsionally compliant coupler in a load path between a stepper motor and a gripper mechanism, the coupler including a coupler input member coupled to the stepper motor, a coupler output member coupled to the gripper mechanism, a torsion spring disposed between the coupler input member and the coupler output member, and a stop member arranged to engage a stop engagement protrusion to provide a one-way hard stop. The method includes measuring an angular position of the stepper motor. The method includes measuring an angular position of the gripper mechanism. The method includes operating in a position control mode when the stop member is engaged with the stop engagement protrusion, wherein the coupler input member and the coupler output member rotate together. The method includes transitioning to a torque control mode when a gripping force causes the stop member to disengage from the stop engagement protrusion. The method includes determining a coupler deflection from a difference between the angular position of the stepper motor and the angular position of the gripper mechanism. The method includes calculating an output torque applied to the gripper mechanism based on the coupler deflection and a torsional stiffness of the torsion spring.

Additionally or alternatively, measuring the angular position of the stepper motor comprises measuring with a first encoder, and measuring the angular position of the gripper mechanism comprises measuring with a second encoder.

Additionally or alternatively, the method further includes applying a preload to the torsion spring such that the stop member is biased into contact with the stop engagement protrusion when no external load is applied to the gripper mechanism.

Additionally or alternatively, the method further includes rotating the stepper motor in a gripper opening direction after gripping an object, re-engaging the stop member with the stop engagement protrusion as the coupler deflection decreases, and applying negative torque through the engaged stop member to overcome friction in the gripper mechanism and release the object.

Additionally or alternatively, calculating the output torque comprises multiplying the coupler deflection by a spring stiffness constant of the torsion spring, and adding a preload torque value to produce the output torque.

Additionally or alternatively, the method further includes comparing the calculated output torque to a target torque value, adjusting the angular position of the stepper motor based on the comparison, and repeating the determining and calculating steps until the output torque reaches the target torque value.

Additionally or alternatively, the method further includes detecting contact between gripper fingers of the gripper mechanism and an object based on a change in the coupler deflection while the stepper motor continues to rotate.

Additionally or alternatively, the method further includes averaging a plurality of torque readings to determine a measured torque value, and comparing the measured torque value to a threshold based on a preload value and a torque noise value.

Additionally or alternatively, the method further includes commanding a steady acceleration of the stepper motor up to a cruise velocity during an initial phase of torque control, and transitioning to proportional control when a proportional controller velocity command falls below a current velocity of the stepper motor.

Additionally or alternatively, the method further includes verifying that the coupler is in the preload condition by commanding a test move in the gripper opening direction and measuring a torque change, wherein a torque change below a noise threshold indicates the preload condition.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A is a front view of a thermal autosampler gripper apparatus, in accordance with some embodiments.

FIG. 1B is a front cross-sectional view of the thermal autosampler gripper apparatus of FIG. 1A, in accordance with some embodiments.

FIG. 2A is a front view of a torsion coupler of FIGS. 1A and 1B including a view of an interior of the coupler, in accordance with some embodiments.

FIG. 2B is a top view of the torsion coupler of FIG. 2A.

FIG. 2C is an illustrative view of a motor interface of the coupler of FIGS. 1A-2B, in accordance with some embodiments.

FIG. 2D is an illustrative view of a gripper interface of the coupler of FIGS. 1A-2B, in accordance with some embodiments.

FIG. 2E is an illustrative view of the gripper interface of FIG. 2D coupled to an output shaft, in accordance with some embodiments.

FIG. 3A is a perspective view of the coupler of FIGS. 1A-2E including direction annotations, in accordance with some embodiments.

FIG. 3B is a front view of the thermal autosampler gripper apparatus of FIGS. 1-3A including direction annotations, in accordance with some embodiments.

FIGS. 4A, 5A, 6A, 7A, 8A, and 9A are top views of sequential operational steps of a thermal autosampler gripper apparatus including relevant torques and angular velocities during an object transport operation, in accordance with some embodiments.

FIGS. 4B, 5B, 6B, 7B, 8B, and 9B are bottom views of the sequential operational steps of the thermal autosampler gripper apparatus of FIGS. 4A, 5A, 6A, 7A, 8A, and 9A, respectively.

FIG. 10 is a flow diagram of a method for controlling a force applied to an actuated mechanism, in accordance with some embodiments.

FIG. 11A is a flow diagram of a method for measuring torque in a thermal autosampler gripper apparatus, in accordance with some embodiments.

FIG. 11B is a continuation of the flow diagram of FIG. 11A, in accordance with some embodiments.

FIG. 12A is a flow diagram of a method for verifying a preload condition of a torque control mechanism, in accordance with some embodiments.

FIG. 12B is a continuation of the flow diagram of FIG. 12A, in accordance with some embodiments.

FIG. 12C is a continuation of the flow diagram of FIG. 12B, in accordance with some embodiments.

FIG. 13A is a flow diagram of a method for handling a torque control command in a thermal autosampler gripper apparatus, in accordance with some embodiments.

FIG. 13B is a continuation of the flow diagram of FIG. 13A, in accordance with some embodiments.

FIG. 14A is a flow diagram of a validation and setup portion of a method for torque control of an autosampler gripper apparatus, in accordance with some embodiments.

FIG. 14B is a flow diagram of a startup phase of the method of FIG. 14A, in accordance with some embodiments.

FIG. 14C is a flow diagram of a steady acceleration control routine of the method of FIG. 14A, in accordance with some embodiments.

FIG. 14D is a flow diagram of a proportional control routine of the method of FIG. 14A, in accordance with some embodiments.

FIG. 14E is a flow diagram of a velocity command saturation routine of the method of FIG. 14A, in accordance with some embodiments.

FIG. 14F is a flow diagram of a final check state of the method of FIG. 14A, in accordance with some embodiments.

FIG. 15 is a plot of motor velocity and coupler measured torque versus time illustrating results of a torsion coupler torque controller for a thermal autosampler gripper apparatus, in accordance with some embodiments.

FIG. 16 is a side view of an autosampler gripper apparatus, in accordance with some embodiments.

FIG. 17 is a cross-sectional view of the autosampler gripper apparatus of FIG. 16, in accordance with some embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments of the present inventive concept address the limitation that stepper motors have no intrinsic means of monitoring or controlling output torque. The inventive concept includes a torsionally compliant coupler, also referred to as a coil torsion spring coupler or simply a torsion coupler or coupler, that is positioned in the load path between a stepper motor and an end effector, and two encoders, one to measure the angular position of the stepper motor (IE coupler input) and one to measure the angular position of the end effector input (IE coupler output).

The torsion coupler includes a coupler input member that receives a motor shaft, a coupler output member that connects to a gripper mechanism, and a spring positioned between the coupler input member and the coupler output member. The coupler input member includes a stop member that interacts with at least one stop engagement protrusion extending inwardly from the coupler output member. A preload adjustment screw extends from the stop engagement protrusion to establish an initial angular position of the stop member relative to the coupler output member.

The torsion coupler operates in two primary conditions. In a preload condition, the stop member directly abuts the preload adjustment screw, the spring biases the coupler input member against the stop engagement protrusion, and the coupler input member and coupler output member rotate together as a unit. In this preload condition, the system operates in a position control mode where the motor angular position directly controls the gripper position. When the gripper fingers contact an object such as a sample pan, the force of the object against the fingers resists further rotation of the coupler output member. As the motor continues to rotate, the motor torque overcomes the spring preload, causing the stop member to disengage from the preload adjustment screw. In this deflected condition, the coupler input member rotates relative to the coupler output member, winding the spring and thereby increasing the gripping force applied by the fingers to the object. The system now operates in a torque control mode.

The deflection, or angular displacement, of the torsion coupler is the difference between the angular position of the coupler input and output. The coupler has a near linear relationship between torque applied to it and its deflection, i.e., the coupler has a constant torsional compliance Kₛₚ (described below). As a result, a simple linear model can be used to predict the output torque of the coupler based on the coupler's deflection. Thus, by measuring the coupler deflection using the two encoders positioned on the input and output of the coupler, respectively, the output torque of the coupler, i.e., the torque applied to the end effector, neglecting dynamic effects, friction, etc., can be measured. In some embodiments, the angular position of the stepper motor may be determined by tracking the commanded position of the stepper motor rather than by using a dedicated encoder at the motor. Because stepper motors receive pulses that are converted to mechanical motion, the controller may track the number of pulses sent to the stepper motor to determine the motor angular position. In such embodiments, only a single encoder positioned at the coupler output may be required to measure the gripper mechanism angular position. While gross inaccuracies such as stepper motor stalling may affect the accuracy of the tracked motor position, the controller may implement software routines to detect and mitigate such conditions. The introduction of a known compliance translates the stepper motor's positional control into fine torque control, providing a cost effective actuation scheme with simple, stable torque and position control.

The geometry of the stop member and stop engagement protrusion provides a one-way hard stop that makes the coupler torsionally compliant in the gripper closing direction but torsionally rigid in the gripper opening direction. This one-way hard stop allows for spring preload, avoids oscillation about equilibrium, provides position control under no torque conditions, and enables reliable, smooth gripper opening even when static friction is present. When the motor rotates in the grip open direction, the stop member re-engages with the preload adjustment screw, and the coupler input member pushes against the coupler output member through the substantially rigid stop member, enabling the system to apply negative torque to overcome friction and smoothly open the gripper fingers. The one-way hard stop functionality may also assist in detecting gross inaccuracy conditions such as stepper motor stalling, as unexpected changes in the measured coupler deflection relative to the commanded motor position may indicate a fault condition.

Further, by controlling coupler deflection using a stepper motor rotor angle as the control input, and the deflection as measured by the two encoders as feedback, torque applied to the end effector by the coupler can be controlled.

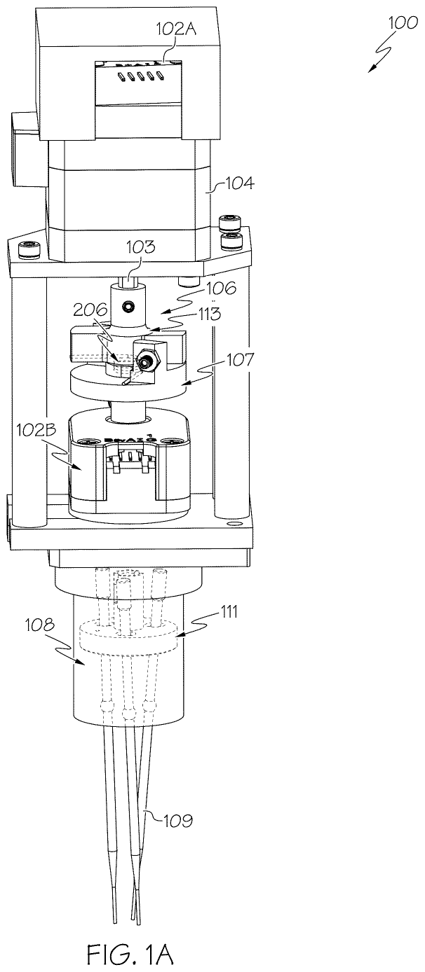

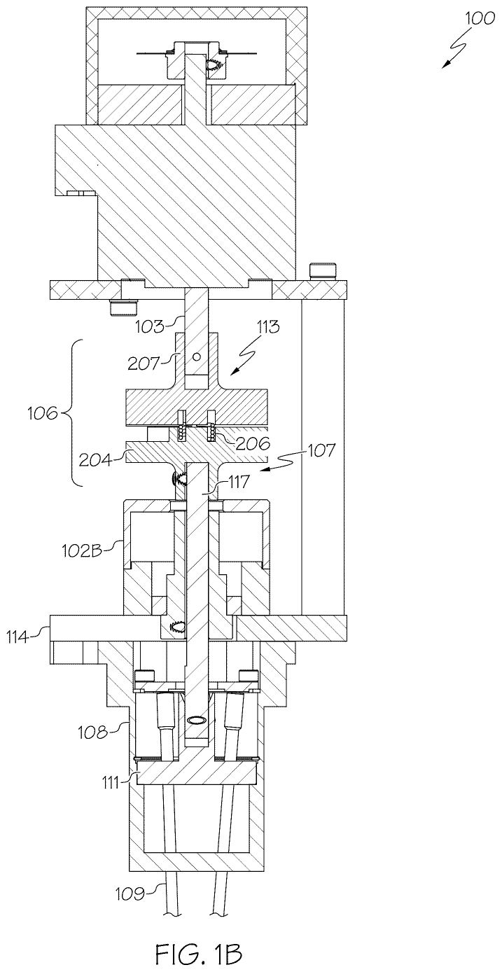

FIG. 1A is a front perspective view of a thermal autosampler gripper apparatus 100, in accordance with some embodiments. FIG. 1B is a front cross-sectional view of the thermal autosampler gripper apparatus 100 of FIG. 1A, in accordance with some embodiments.

In some embodiments, the gripper apparatus 100 is constructed and arranged to perform sample handling operations for a thermal autosampler or the like, but not limited thereto. For example, an autosampler may move pans comprising prepared samples between a tray and a cell. As shown, the thermal autosampler gripper apparatus 100 includes a pair of encoders 102A, 102B (generally, 102), a stepper motor 104, a torsion coupler 106, and a gripper mechanism 108. The torsion coupler 106 may be referred to as a torque control mechanism.

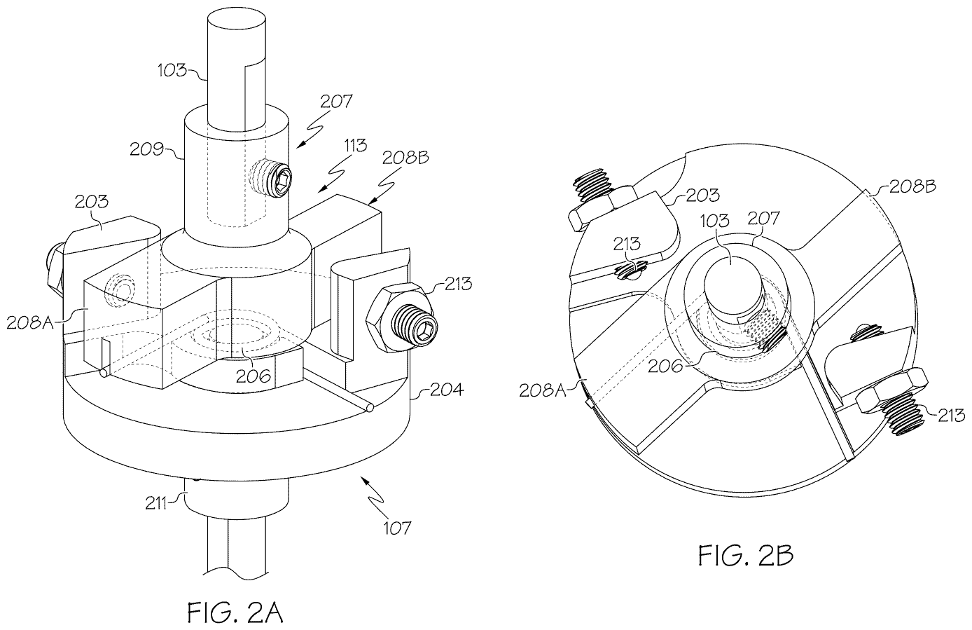

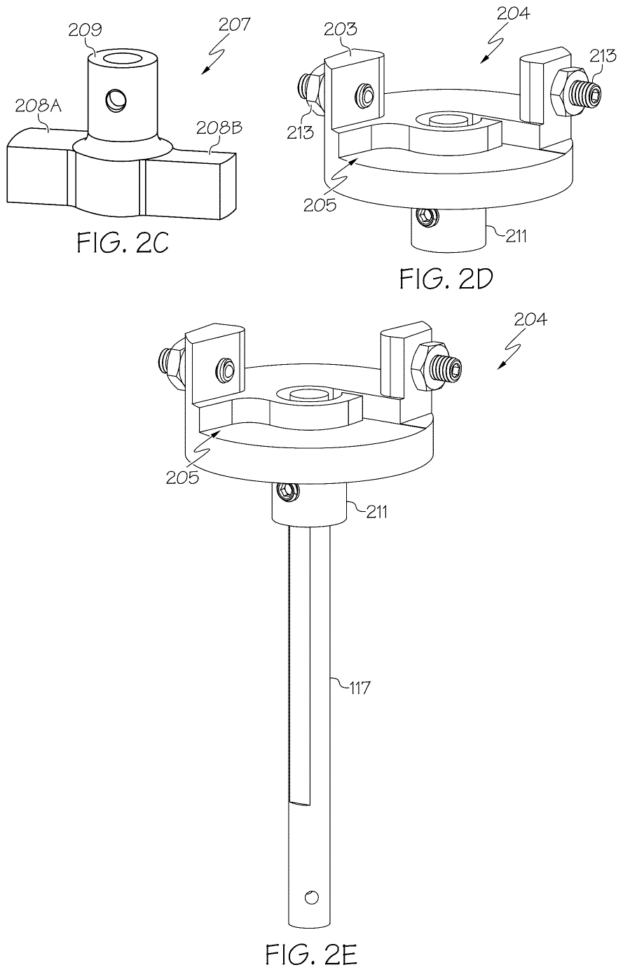

As shown, the first encoder 102A, also referred to as a motor encoder, may be part of the stepper motor 104 along with a transmission, gearbox, and/or other relevant components (not shown). In some embodiments, the actuator is a rotatable actuator comprising the motor 104 disposed within the actuator body and configured to rotate a rotationally actuated gripper mechanism 108. In some embodiments, the first encoder 102A is a rotary encoder positioned at the motor 104 for determining the angular position, or more specifically, stepper motor rotor angle, of the motor 104 and its output shaft 103 at the input at the coupler input 113 of the coupler 106. In other embodiments, the angular position of the motor 104 may be determined by tracking the commanded position based on the pulses sent to the stepper motor 104 rather than by using a dedicated encoder, in which case the first encoder 102A may be omitted. The coupler 106 extends from the coupler input 113 where the motor shaft 103 is installed in the coupler input member, which is coupled to the coupler output 107, more specifically, the coupler output member (FIG. 2) by a torsional spring 206. The rotor angle is controlled by the stepper motor 104 and measured by the first encoder 102A. The second encoder 102B is positioned below the coupler 106 and is arranged to determine an angular position of the gripper mechanism 108. The stepper motor 104 actuates the coupler 106, which in turn actuates the gripper 108, or more specifically, particularly, the gripper rotor 111 coupled to an output shaft, also referred to as a second shaft 117. The second shaft 117 is coupled to a coupler output 211 or gripper shaft extending from a coupler output member at the coupler output 107 (see FIGS. 2D and 2E). The second shaft 117 may be a drive shaft, screw rod, or other elongated component that moves the gripper 108. Accordingly, by taking the difference in readings between the first encoder 102A and second encoder 102B, the system can infer and/or control torque applied to the gripper rotor 111.

In some embodiments, the gripper apparatus 100 includes one or more gripper fingers 109 for grasping temporary storage devices, pans, or the like containing samples of interest. The fingers are powered by an actuator which creates the gripping motion to pick up and release such objects. During operation, it is desirable to control the actuator torque as applied to the gripper rotor 111. The combination of encoders 102 and coupler 106 positioned between the stepper motor 104 and gripper mechanism 108 can measure coupler deflection and may use the measured deflection to compute a torque by, for example, multiplying the deflection (in degrees by a spring constant (kₛₚ) or torque per unit deflection or known torsional spring stiffness value) of a spring (see FIG. 2A). The model of the coupler behavior allows estimation of torque from the deflection. The known relationship between coupler deflection (related to stepper motor position) and coupler torque is used to translate the stepper motor's position control into torque control. Further, the relative compliance of the torsion coupler allows for fine torque control.

FIGS. 2A and 2B are front and top views of the torsion coupler 106 of FIGS. 1A and 1B, in accordance with some embodiments. As shown in FIG. 2A, the torsion coupler 106 further comprises a coil torsion spring 206, a coupler input member 207 (see also FIG. 2C), and a coupler output member 204 (see also FIG. 2D). In some embodiments, the torsion coupler 106 has a cylindrical main body or housing (not shown) constructed and arranged for positioning about the coil torsion spring 206, coupler input member 207, and a coupler output member 204. The coupler input member 207 is positioned at the coupler 106 for coupling to the motor shaft 103 (referred to as a first shaft) (see FIG. 1B). The coupler output member 204 is positioned at the coupler output 107 of the coupler 106 for coupling to the output shaft 117 to the gripper 108, respectively. As shown in FIG. 2A, the coupler input member 207 includes a cylindrical coupler input 209 configured to receive the motor shaft 103, and a stop member 208 extending from the cylindrical coupler input 209. When the motor shaft 103 rotates, the entire coupler input member 207, including the stop member 208, rotates with it.

As shown in FIG. 2A, the coil torsion spring 206 is sandwiched between the coupler output member 204 and the coupler input member 207. Although a coil torsion spring 206 is shown and described, other embodiments of a spring may equally apply, for example, a spring having a helical or spiral profile. One end of the spring 206 is coupled to the coupler input member 207, which in turn is coupled to the motor shaft 103. The other end of the spring 206, in some embodiments, is affixed to the coupler output member 204 or other portion of the coupler element. As described herein, the spring 206 provides a controlled torque to both the coupler input member 207 and coupler output member 204.

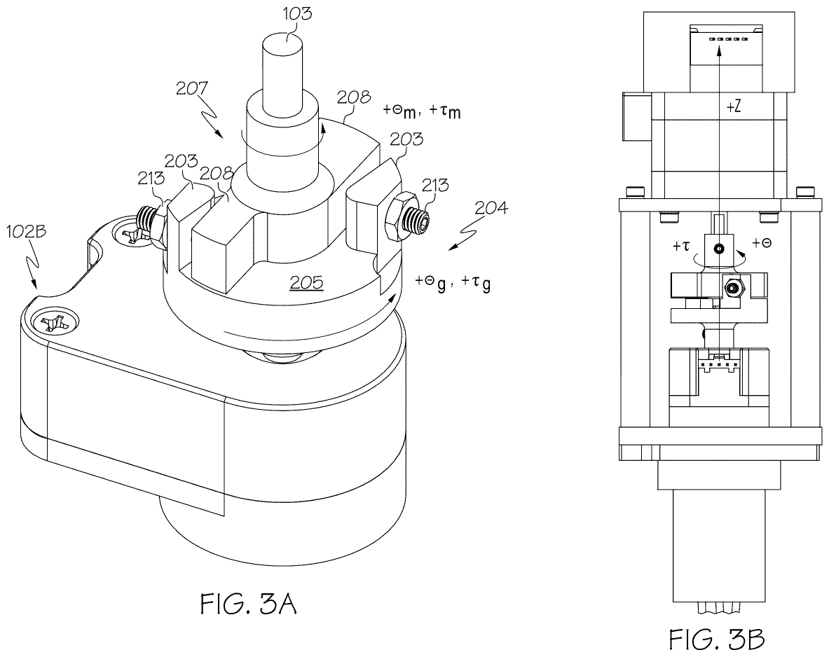

As shown in FIGS. 3A and 3B, the tabs or stop members 208A, 208B (generally) of the coupler input member 207 extending 180 degrees from each other provide a “one way hard stop”. In some embodiments, each stop member 208A, 208B has a different dimension such as a width as shown. More specifically, the coupler input member 207, which includes the stop members 208, can rotate inside an interior 205 of the coupler output member 204, for example, shown by a directional arrow (A). The stop engagement protrusion 203 extends inwardly from the coupler output member 204 into the interior 205. When the coupler input member 207 rotates and the coupler output member 204 is relatively stationary, or when the rotation of the coupler input member 207 is greater than the rotation of the coupler output member, the spring 206 (not shown in FIG. 3A) is wound, which creates torque. As shown, the stop member 208 has a generally rectangular shape, i.e., a length greater than a width. In some embodiments, the width of the stop member 208 includes curved edges to align with the cylindrical contours of the coupler output member 204. The coupler input member 207 coupled to the input shaft 103 can rotate in the interior region 205 when the input shaft 103 rotates. However, the stop member 208 is prevented from a 360 degree rotation relative to the coupler output (gripper side) so that the coupler doesn't deflect perpetually. The stop engagement protrusion 203 has a hole for receiving a preload adjustment screw 213.

The geometries and arrangement of the stop member 208 and coupler output member interior 205 correspond to the opening and closing of the gripper 108 so that the coupler 106 is torsionally compliant in the gripper closing direction when the motor shaft 103 and stop member 208 rotates in a first direction. For example, as shown in FIG. 3A, the grip close direction +Θ is illustrated. The coupler 106 can be in the torsionally stiff mode while rotating in either direction, provided the stop member 208 remains engaged with the stop engagement protrusion 203. The coupler 106 exits the torsionally stiff mode and enters the torsionally compliant mode when the gripper fingers 109 contact an object and the coupler 106 is rotating in the +Θ direction. Once in the torsionally compliant mode, the coupler 106 can only return to the torsionally stiff mode by rotating in the −Θ direction until the stop member 208 re-engages with the stop engagement protrusion 203. This arrangement prevents the gripper 108 from snapping open when trying to release a gripped object. The one-way hard stop allows for spring preload, avoids oscillation about equilibrium, provides position control under no torque conditions, and enables reliable, smooth gripper opening even when stiction is present. In other words, the prevention of the motor shaft 103 and stop member 208 from further rotation in the second direction at the stop engagement protrusion 203 permits negative (opening) torque to be created without rotating the torsional spring in the negative direction beyond its equilibrium position.

As shown in FIGS. 3A and 3B, the directional arrow (A) is shown as rotating the motor shaft 103 and stop member 208 of the coupler input member 207 in a “grip close direction (+Θ).” Also shown are the motor angle Θₘ, or coupler input angle, and the gripper angle Θ_{g}, or coupler output angle. The torque direction is defined in the same sense as rotation direction, i.e., τₘ is torque applied to the coupler input (motor side) which tends to cause it to rotate in the +Θ direction.

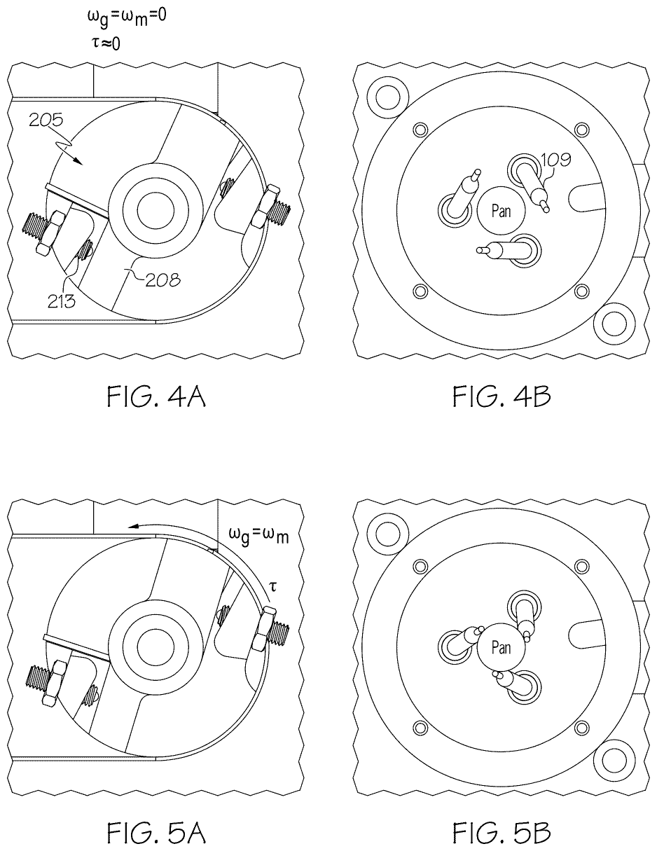

FIGS. 4A, 5A, 6A, 7A, 8A, and 9A are top views of sequential operational steps of the thermal autosampler gripper apparatus 100 of FIGS. 1-3B, in accordance with some embodiments. FIGS. 4B, 5B, 6B, 7B, 8B, and 9B are bottom views of the sequential operational steps of the thermal autosampler gripper apparatus 100 of FIGS. 4A, 5A, 6A, 7A, 8A, and 9A, respectively. In FIGS. 4A-9B, friction, gravity, and dynamic effects will be neglected for the purpose of simplifying the explanation of the inventive concept. Thus, the motor torque (τₘ) is equal to the gripper torque (τ_{g}) at all times. Thus, we may refer to both quantities as τ shown in FIG. 3B. However, the spring torque (τₛₚ) of the spring 206 may not equal the torque τ shown in FIG. 3B. The theory of operation in some embodiments of the present inventive concept is described as follows.

In FIGS. 4A and 4B, the coupler 106 is in a preload state or condition, where the stop member 208 is engaged, namely, the gripper fingers 109 do not contact an object such as a pan and the spring 206 is deflected some initial amount, i.e., preloaded. In this preload condition, the gripper fingers 109 are in a fully separated open position and are not contacting the pan because they are spread apart. In this initial state, the spring 206 biases the coupler input member 207 against the stop engagement protrusions 203 via the preload adjustment screws 213. The spring bias creates an internal preload torque that keeps the stop member 208 in direct contact with the preload adjustment screws 213. The coupler input member contacts the preload adjustment screws 213 in a manner that defines the preload condition. The spring 206 generates a preload torque, which applies to the upper and lower sections of the coupler 106, but this preload torque is balanced by the by the interaction between the stop member of the coupler input member and the stop engagement protrusion of the coupler output member and thus the preload torque is purely internal to the coupler 106. Here, the coupler output angle (Θ_{g)} and the coupler input angle (Θₘ) are equal in view of the reference frame shown in FIG. 3A which is defined as a 0 angle indicative of the gripper fingers 109 in an open state as shown in FIG. 4B.

In FIGS. 5A and 5B, torque control command is initiated, which causes the coupler to start rotating. Similar to FIGS. 3A and 3B, the directional arrow is shown as rotating the motor shaft 103 and stop member 208 causing the gripper fingers 109 to close as shown in FIG. 5B. Here, the coupler output angle (Θ_{g)} is equal to the coupler input angle (Θₘ). During this initial closing motion, before the fingers contact the pan, the coupler input member 207 and coupler output member 204 rotate together as a unit because the stop member 208 remains engaged against the stop engagement protrusion 203. The spring preload keeps these components locked together, so both rotate in the same direction at the same rate as the fingers narrow toward the pan. Because the stop member 208 remains engaged against the preload adjustment screws 213, rotation of the coupler output member 204 directly causes rotation of the gripper rotor 111, which in turn causes the gripper fingers 109 to narrow toward the pan. Here, the value of the Θ_{g} and Θₘ at this instant is defined as “a,” where Θ_{g}=Θₘ=a, at the instant the gripper fingers 109 contact the object. When the fingers 109 contact the pan, the grip force starts increasing beyond 0 and climbs as the motor continues to rotate. In the condition of FIG. 5B, the stop member 208 remains engaged, i.e., in a preload condition described with respect to FIG. 4A. However, the application of the external motor torque (τₘ) starts shifting the load off the stop member 208. The spring torque τₛₚ=preload Tq as in FIG. 4A, but at least part of the spring torque τₛₚ is now resisting the motor torque τₘ, thereby transmitting the motor torque τₘ to the gripper 108, creating the gripper torque τ_{g}. Note that the gripper torque and motor torque are always equal.

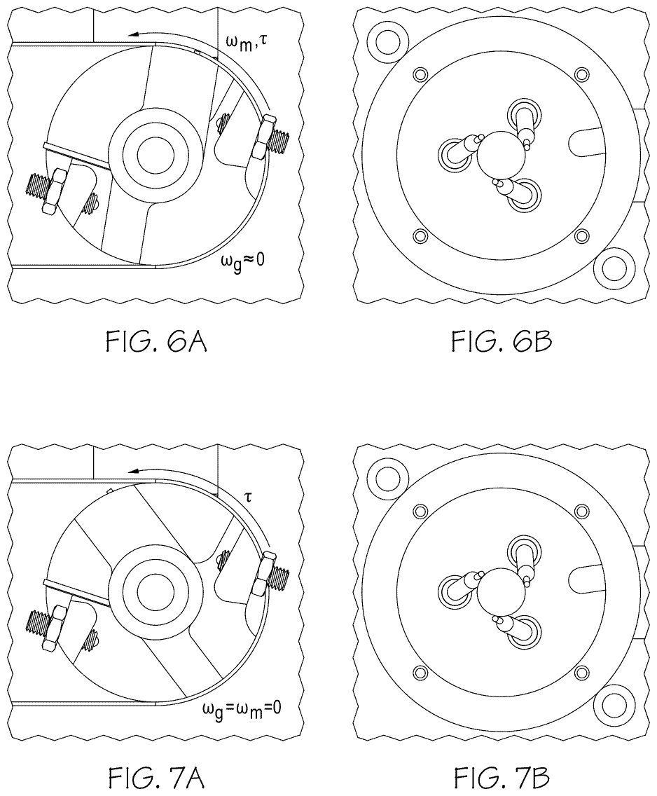

In FIGS. 6A and 6B, the motor angular position Θₘ continues to increase, but the gripper angular position Θ_{g} and therefore the gripper fingers 109 remain relatively stationary because the fingers are in contact with the pan, although the fingers 109 and other members of the load chain may deflect some allowing the gripper angular position Θ_{g} to increase slightly. The stop member 208 in this step is now disengaged, i.e., no longer in direct contact with the adjustment screws 213. Once the fingers contact the pan, the force of the pan against the fingers is translated through the gripper mechanism to the coupler output member 204, which resists further rotation. This resistance causes the motor torque to overcome the spring preload, separating the stop member 208 from the preload adjustment screws 213. Thereafter, continued rotation of the coupler input member 207 relative to the now-stationary coupler output member 204 winds the spring 206, thereby increasing the gripping force applied by the fingers to the pan. Here, the coupler 106 is in a deflected state determined as (Θₘ−Θg). The spring torque τₛₚ has increased beyond a preload state due to deflection, and τₛₚ=kₛₚ*(Θₘ−Θ_{g})+τₚₗ (eq 1) now applies. Since the stop member 208 is disengaged, the spring torque (τₛₚ)=τ_{g}=τₘ=τ. The gripper torque τ_{g} (and therefore finger tightness) can now be controlled by controlling the motor angle Θₘ. The controller (not shown), in communication with the motor and encoders, determines the position and/or velocity of the stepper motor and in doing so can continue increasing motor angular position Θₘ to reach the target torque τ_{targ}. The controller calculates the torque τ by measuring Θₘ and Θ_{g}, and inputting these values into equation (eq 1) above.

As shown in FIGS. 7A and 7B, motor angular position, or coupler input angle Θₘ, has increased further, but Θ_{g}≈a. Thus, the coupler deflection has increased further. The controller detects that the coupler deflection has reached the target torque τ_{targ}, so the controller stops the motor 104. The system now rests at the target torque and target grip tightness. As shown in FIG. 7B, the object, for example, a sample pan, is now securely gripped and ready for transport by the autosampler.

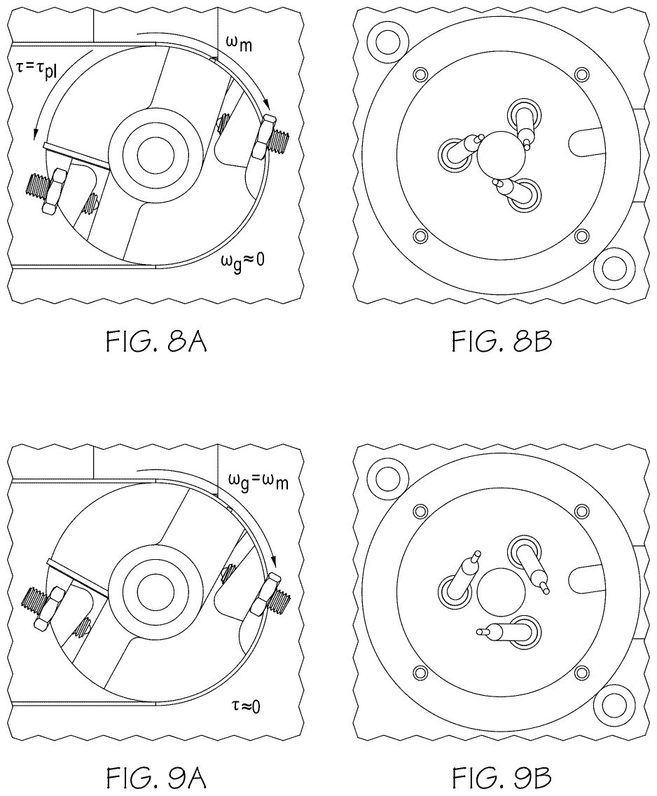

In FIGS. 8A and 8B, the autosampler or other robotic apparatus moves the gripper apparatus 108 to a target location for releasing the pan from the gripper fingers 109. Here, controller starts to move the motor to release the object, e.g., sample pan. The motor angular position Θₘ decreases while the gripper angular position Θ_{g} still stays mostly fixed. Thus, the coupler deflection decreases, which decreases the torque τ until the stop members 208 contact the preload adjustment screws 213. The torque τ equals the preload τₚₗ the instant just before the stop member 208 is re-engaged.

With the stop member 208 re-engaged, the spring 206 is no longer in the load path, and Θₘ=Θ_{g}. As long as the coupler 106 continues moving in the −Θ direction (grip open direction), the stop member 208 will stay engaged. In this condition, τ will be whatever is required to keep Θₘ=Θ_{g}. This is important for opening the gripper 108 with some friction present, in particular, friction between the fingers 109 and pan and joints within the gripper 108 mean that a negative torque (τ_{g}<0) is required to release the pan. Here, a negative τ (clockwise τ from top down perspective as shown in FIGS. 4-9) is necessary to overcome friction in the load chain to move the fingers 109 from the state shown in FIG. 8B to the grip open position shown in FIG. 9B. Because the stop member 208 is substantially rigid, when the motor angular position Θₘ decreases, the coupler input member 207 pushes against the coupler output member 204 through the stop member 208, forcing Θ_{g} to decrease by the same amount. This rigid coupling through the engaged stop member 208 enables the system to apply the negative torque required to overcome friction and smoothly open the gripper fingers 109.

For example, consider the motor angular position Θₘ decreasing by 1° more from the snapshot. As it rotates, the stop member feature 208 of the coupler input member 207 pushes into the coupler side. Since the stop member 208 is substantially rigid, it requires that Θₘ=Θ_{g} (a violation of this condition would require that the stop member compress). Thus, when Θₘ opens by 1°, the coupler input member 207 will apply a force to the coupler side 204 as hard as it needs to for Θ_{g} to also open by 1°. Here, the coupler 106 may rotate due to the stepper motor shaft rotation. This behavior is the “position control” mode of operation. In this way, the gripper fingers 109 will be smoothly forced back to the open position (starting position) as the motor angular position Θₘ returns to its starting angle.

In FIGS. 9A and 9B, the motor angular position Θₘ continues to decrease, driving the gripper angular position Θ_{g} to decrease the same amount. Fingers 109 lose contact with the pan and the pan is released. The motor angular position Θₘ continues moving until it reaches the grip open state (Θₘ=Θ_{g}=0°). The gripper rotor 111, which is coupled to the output shaft 117 of the coupler output member 204, rotates in response to the rotation of the coupler output member 204. Rotation of the gripper rotor 111 in the counterclockwise direction (when viewed from above) narrows the tips of the gripper fingers 109 to grip a pan, whereas rotation in the clockwise direction expands the tips of the gripper fingers 109 to release a pan. The spring preload (described above) ensures that stop member features remain in contact, even with no load on the fingers 109, preventing Θ_{g} from deviating from Θₘ, yielding smooth position control.

To illustrate the importance of the one way hard stop, consider how the system would behave without one. For example, producing a negative torque would require twisting the spring 206 past its equilibrium (τ=0) and winding it in the opposite direction. Eventually, the spring 206 would wind enough to overcome the friction in the gripper 108, then the fingers 109 would suddenly release the pan, and the gripper friction would drop significantly. The spring 206 is still wound though, so the unbalanced −τ would cause the coupler output (gripper side) of the coupler to snap further in the −Θ direction. The coupler output 107 of the coupler 106 can then oscillate about the equilibrium point of the spring, until friction in the system eventually attenuates these oscillations.

As described above, it is desirable to infer a torque applied by a motor to an end effector. The torque can be calculated by applying the following equation (Eq. 1):

$$Torque = {K}_{sp} ( {Θ}_{m} - {Θ}_{g} ) + {τ}_{preload} . \qquad Eq . 1$$

Here, the torsion spring 206 has a constant Kₛₚ or known coil torsion spring stiffness value. The motor/coupler input angular position Θₘ is measured by the first encoder 102A at the input shaft 103 from the motor 104. The coupler output/end effector input angular position Θ_{g} is measured by the second encoder 102B at the output shaft to the gripper 108.

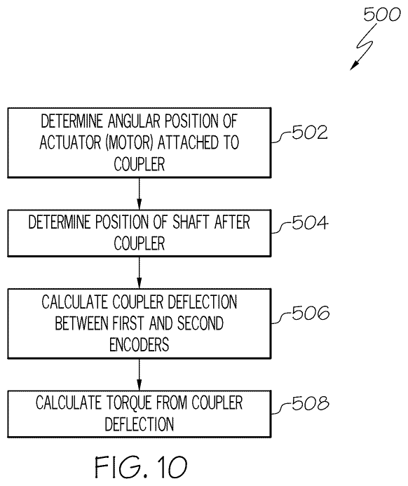

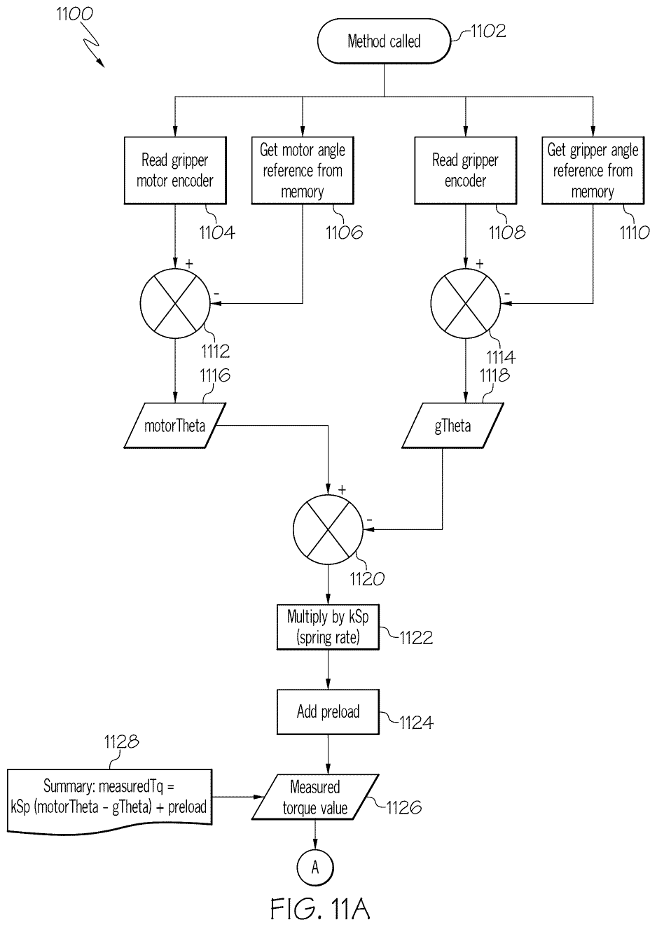

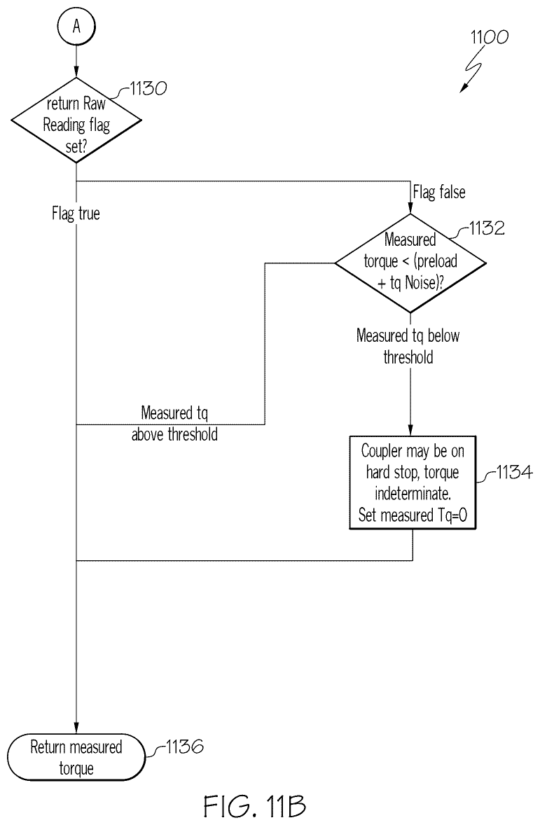

FIG. 10 is a flow diagram of a method 500 for controlling a force applied to an end effector, in accordance with some embodiments. In describing the method 500, reference is made to FIGS. 1-9B.

At step 502, a position of the motor 104 at the input to the torsional coupler 106 is measured, for example, a stepper motor angle using the first encoder 102A or other apparatus monitoring the position of the motor 104.

At step 504, the gripper angular position, or coupler output angle Θ_{g} at an opposite side of the coupler 106 is measured, for example, by the second encoder 102B.

At step 506, the measurements at steps 502 and 504 are used to calculate the deflection of the coupler (Θₘ−Θ_{g}).

At step 508, the torque is calculated from the coupler deflection based on Eq 1.

Since the measured torque is an estimate of the torque being applied to the gripper 108, the controller can modulate the applied torque by controlling the position of the stepper motor and using steps 502-508 to measure the torque for feedback.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special purpose hardware and computer instructions.

FIG. 11A is a flow diagram of a method 1100 for measuring torque in a thermal autosampler gripper apparatus, in accordance with some embodiments. The method 1100 begins at step 1102, where the method is called. From step 1102, the method 1100 proceeds to read the gripper motor encoder at step 1104 and retrieve the motor angle reference from memory at step 1106. In parallel, the method 1100 reads the gripper encoder at step 1108 and retrieves the gripper angle reference from memory at step 1110. At step 1112, the values from steps 1104 and 1106 are combined to calculate a motor angle value. Similarly, at step 1114, the values from steps 1108 and 1110 are combined to calculate a gripper angle value. At step 1116, the motor angle value motorTheta is output, and at step 1118, the gripper angle value gTheta is output. The method 1100 then proceeds to step 1120, where the motorTheta value and the gTheta value are combined. At step 1122, the combined value is multiplied by kSp, which represents the spring rate of the torsion spring. At step 1124, a preload value is added to the result from step 1122. At step 1126, the measured torque value is output. An annotation at step 1128 summarizes the torque calculation, indicating that the measured torque measuredTq equals kSp multiplied by the difference between motorTheta and gTheta plus the preload value.

FIG. 11B is a continuation of the flow diagram of FIG. 11A, in accordance with some embodiments. The method 1100 continues from a connector to step 1130, where the system checks whether a returnRawReading flag is set. If the flag is true, the method 1100 proceeds to step 1136, where the measured torque is returned. If the flag is false, the method 1100 proceeds to step 1132, where the system determines whether the measured torque is less than a threshold value calculated as the sum of a preload value and a torque noise value. If the measured torque is above the threshold, the method 1100 proceeds to step 1136, where the measured torque is returned. If the measured torque is below the threshold, the method 1100 proceeds to step 1134, where the system determines that the coupler may be on the hard stop and the torque is indeterminate, and sets the measured torque equal to zero. After step 1134, the method 1100 proceeds to step 1136, where the measured torque is returned.

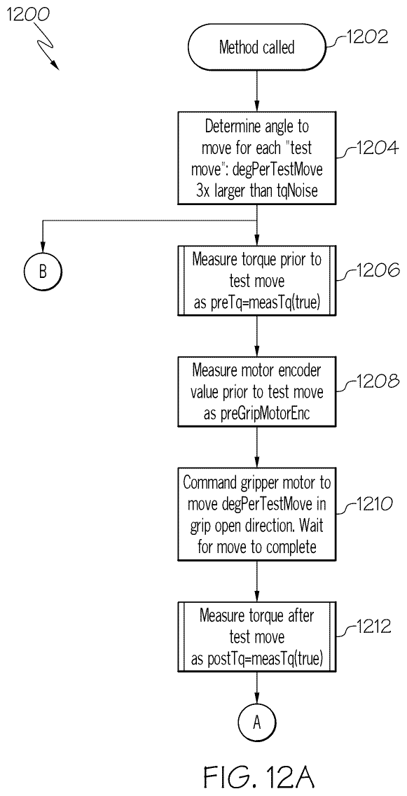

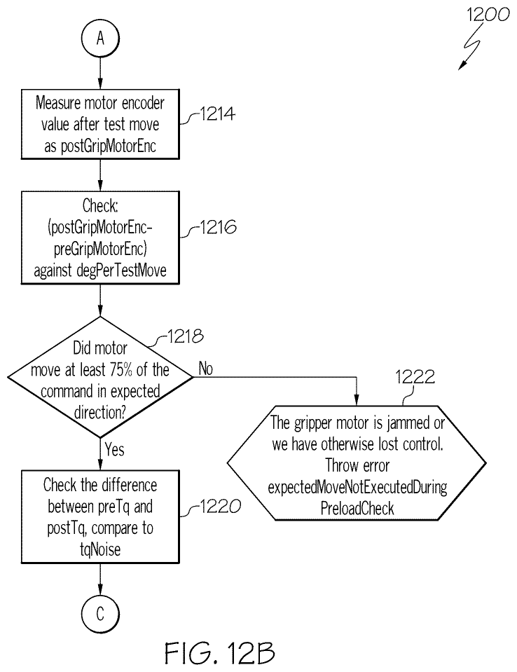

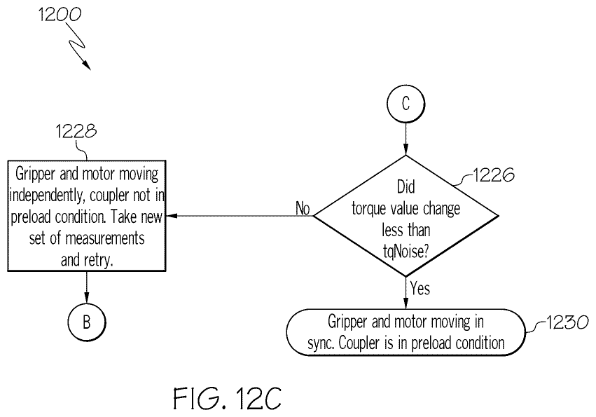

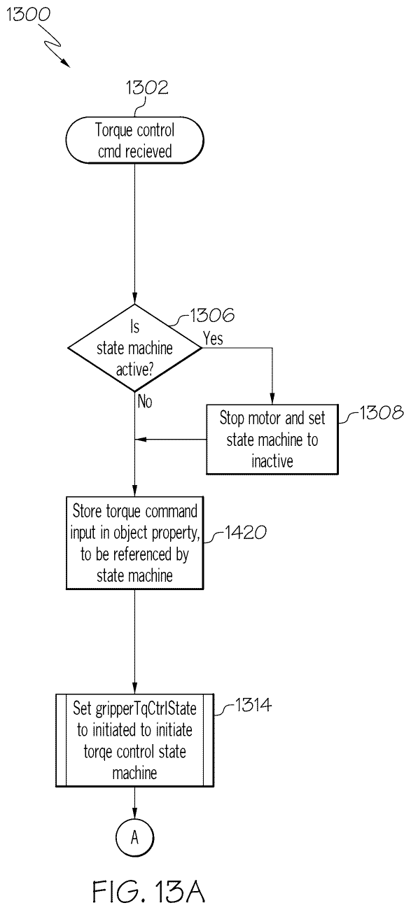

FIG. 12A is a flow diagram of a method 1200 for verifying a preload condition of a torque control mechanism, in accordance with some embodiments. The method 1200 begins at step 1202, where the method is called. The method 1200 proceeds to step 1204, where an angle to move for each test move is determined. The method 1200 then moves to step 1206, where the torque prior to the test move is measured and stored. Following step 1206, the method 1200 proceeds to step 1208, where the motor encoder value prior to the test move is measured and stored. The method 1200 then advances to step 1210, where the gripper motor is commanded to move by a predetermined amount in the grip open direction, and the system waits for the move to complete. After the move completes, the method 1200 proceeds to step 1212, where the torque after the test move is measured and stored.

FIG. 12B is a continuation of the flow diagram of FIG. 12A, in accordance with some embodiments. The method 1200 continues from connector B in FIG. 12A to step 1214, where the motor encoder value is measured after the test move and stored. The method 1200 then advances to step 1216, where a check is performed to determine whether the motor moved at least the commanded amount in the expected direction. At step 1218, if the motor did not move the expected amount, the method 1200 proceeds to step 1220, where the difference between the pre and post values is checked relative to a tolerance. At step 1222, the system determines whether the gripper motor is jammed or has otherwise lost control. If the gripper motor is jammed or has lost control, the method throws an error.

FIG. 12C is a continuation of the flow diagram of FIG. 12B, in accordance with some embodiments. The method 1200 proceeds from connector A of FIG. 12A to step 1226 where a decision is made regarding whether a torque value change is less than a torque noise threshold. From step 1226, the process branches based on the decision outcome. If the torque value change is not less than the torque noise threshold, the process proceeds to step 1228, which indicates that the gripper and motor are moving independently and the coupler is not in a preload condition, and instructs the system to take a new set of measurements and retry. Step 1228 is also the outcome from the output of FIG. 12B. If the torque value change is less than the torque noise threshold, the process proceeds to step 1230, which indicates that the gripper and motor are moving in sync and the coupler is in the preload condition. Verifying the preload condition may be used for initializing a cold system and taring the torque measurement in the preload condition.

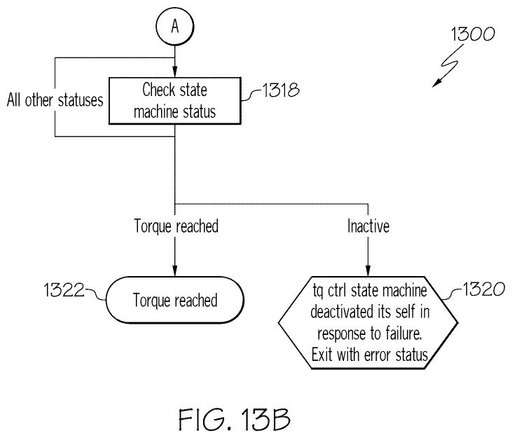

FIG. 13A is a flow diagram of a method 1300 for handling a torque control command in a thermal autosampler gripper apparatus, in accordance with some embodiments. The method 1300 begins at step 1302, where a torque control command is received. This function may serve as a gatekeeper for the torque control state machine and also may serve to block until the state machine finishes or fails. The method 1300 proceeds to step 1306, where the system determines whether the state machine is active. If the state machine is active, the method 1300 proceeds to step 1308, where the motor is stopped and the state machine is set to inactive. The system may alternatively reject commands when torque control is already active. If the state machine is not active, the method 1300 proceeds to step 1312, where the torque command input is stored in an object property to be referenced by the state machine. The method 1300 then proceeds to step 1314, where a gripper torque control state is set to initiated to initiate the torque control state machine.

FIG. 13B is a continuation of the flow diagram of FIG. 13A, in accordance with some embodiments. From the step 1314 of FIG. 13A, the method 1300 continues to a step 1318 where the system checks the state machine status. From step 1318, the method 1300 branches based on the status detected. If the status indicates that torque has been reached, the method 1300 proceeds to step 1322 where the torque reached condition is identified. If the status indicates an inactive state, the method 1300 proceeds to step 1320 where the torque control state machine has deactivated itself in response to a failure, and the method 1300 exits with an error status.

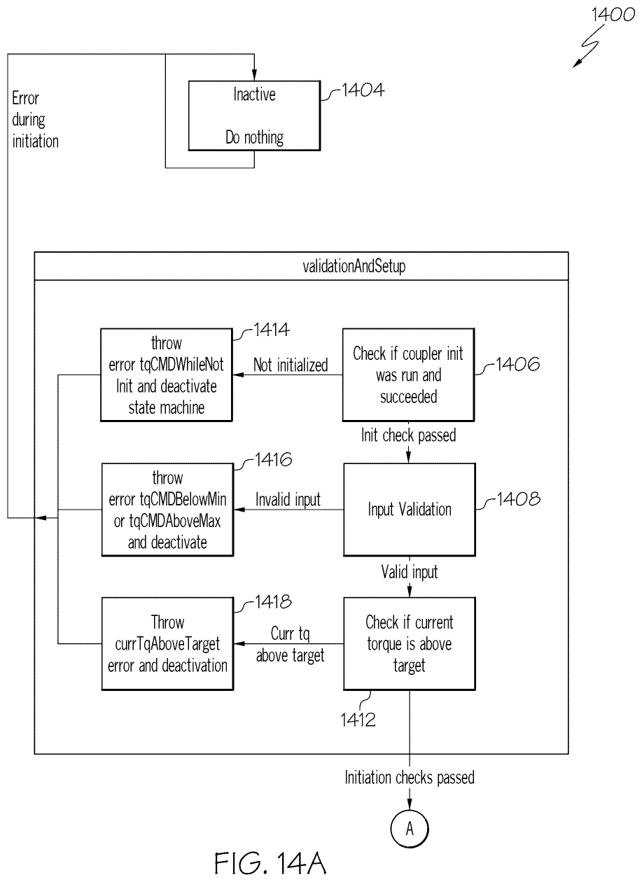

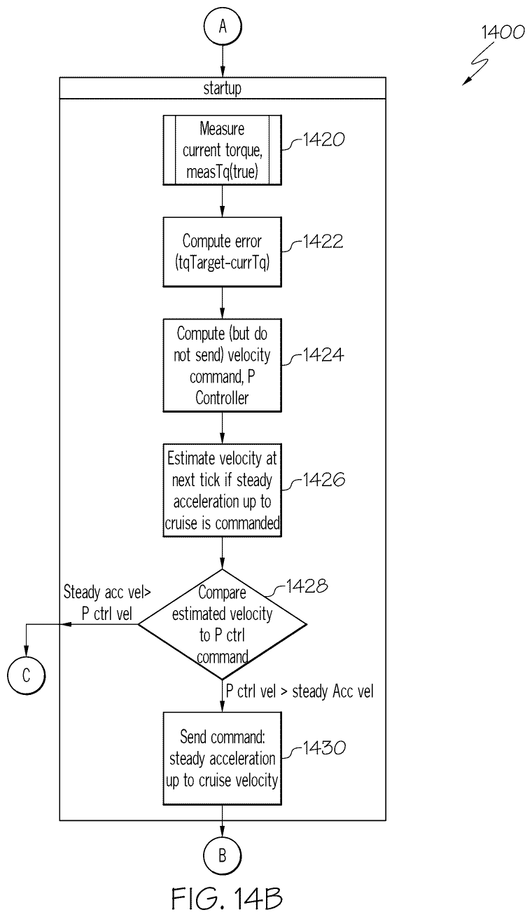

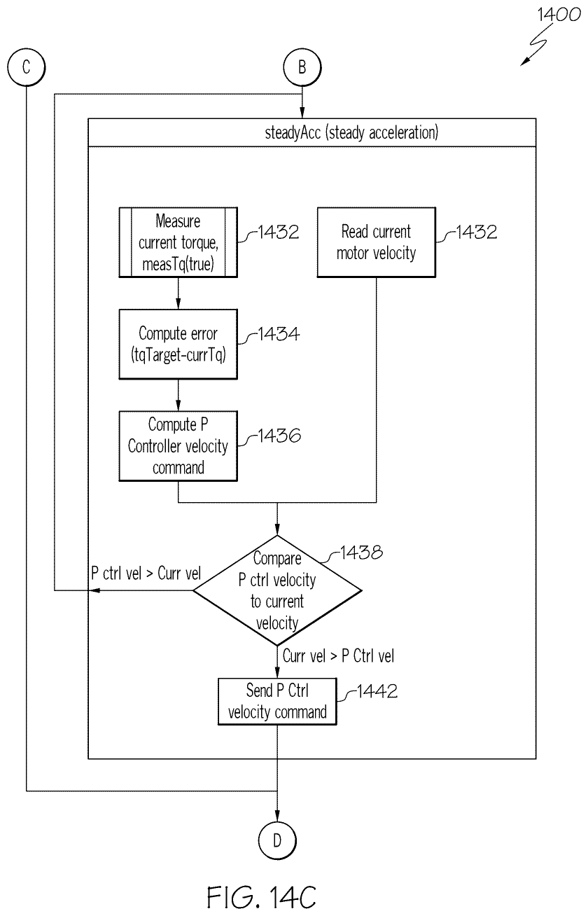

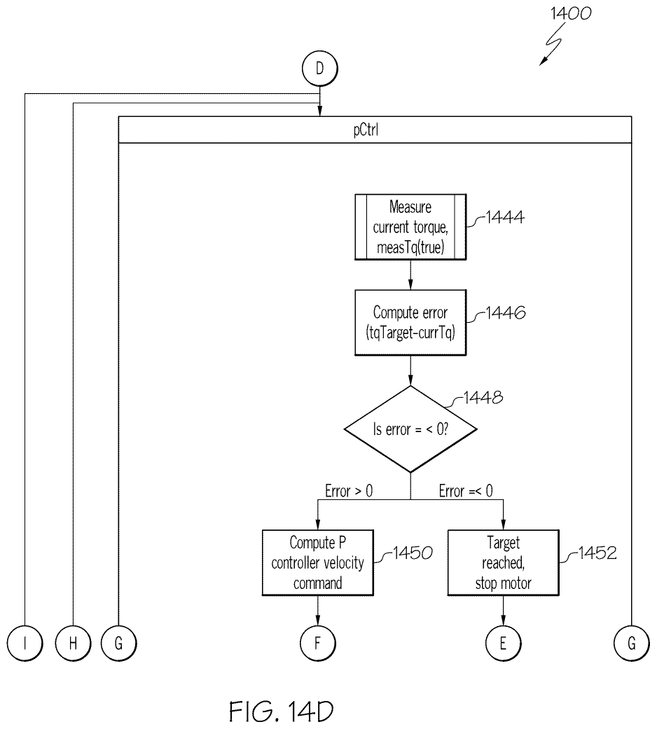

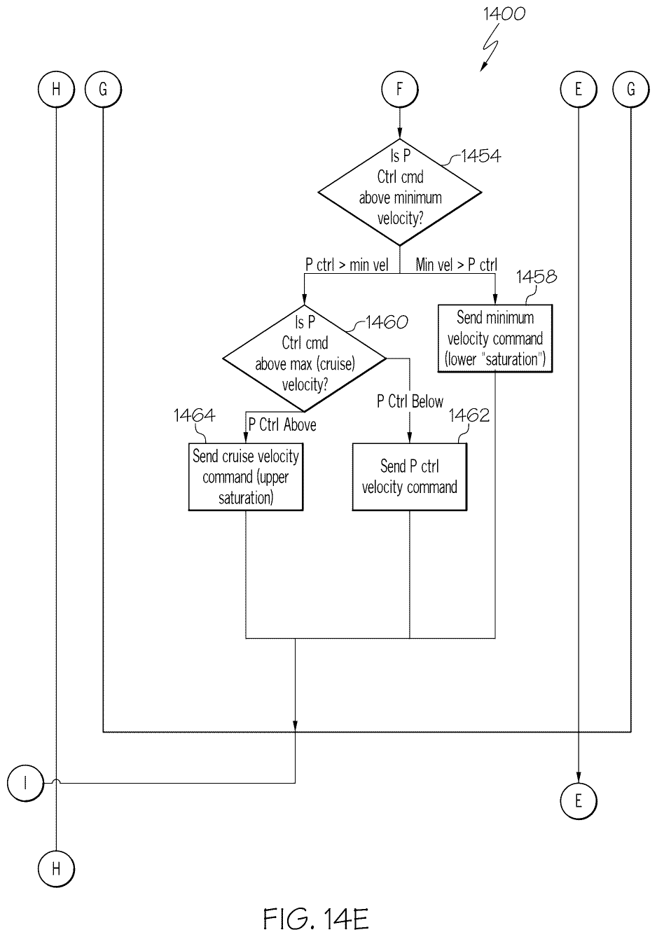

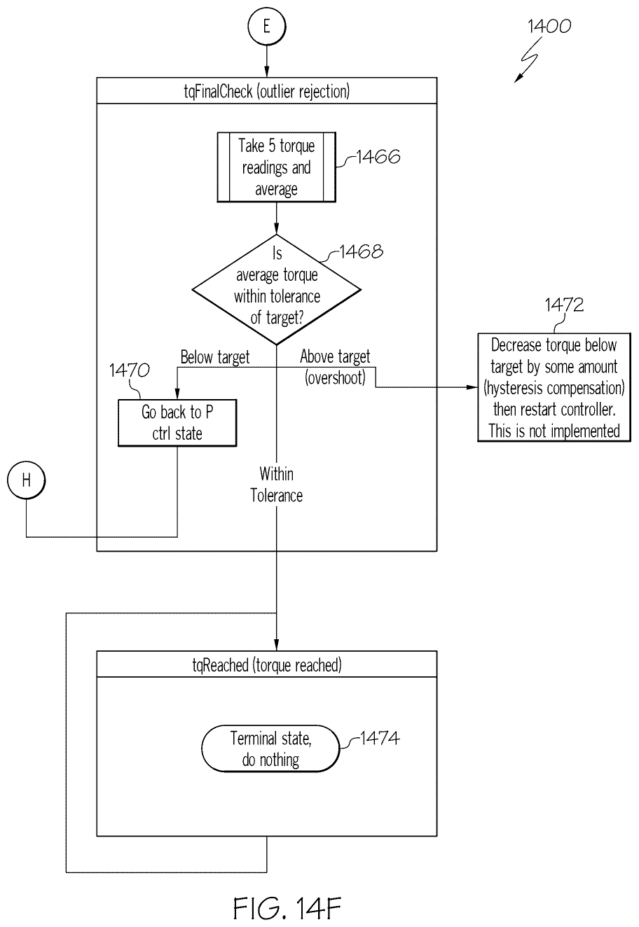

FIG. 14A is a flow diagram of a validation and setup portion of a method 1400 for torque control of an autosampler gripper apparatus, in accordance with some embodiments. The method 1400 begins at step 1404 where the system is in an inactive state. This state may, for example, be exited by an external method changing the state to initiated. The method 1400 proceeds the validation and setup subroutine where various steps occur. At a step 1406, the system checks if coupler initialization was run and succeeded. If the initialization check indicates not initialized, the method 1400 moves to step 1414 where the system throws an error and deactivates the state machine. If the initialization check passed, the method 1400 proceeds to step 1408 for input validation. If the input validation determines invalid input, the method 1400 moves to step 1416 where the system throws an error and deactivates. If the input is valid, the method 1400 proceeds to step 1412 where the system checks if current torque is above the target. The controller may be designed not to reverse to avoid hysteresis. If the current torque is above the target, the method 1400 moves to step 1418 where the system throws an error and deactivates. If the current torque is below the target, the initiation check passes and the method proceeds to FIG. 14B.

FIG. 14B is a flow diagram of a startup phase of the method 1400, in accordance with some embodiments. The method 1400 includes step 1420, where the system measures current torque. The method 1400 then proceeds to step 1422, where the system computes an error value calculated as the difference between a target torque and the current torque. Following step 1422, the method 1400 moves to step 1424, where the system computes but does not send a velocity command using a proportional controller. The method 1400 then proceeds to step 1426, where the system estimates velocity at the next tick if steady acceleration up to cruise is commanded. The method 1400 continues to step 1428, which is a decision step where the system compares the estimated velocity to the proportional controller command. At step 1428, if the steady acceleration velocity is greater than the proportional controller velocity, the method 1400 branches accordingly. If the proportional controller velocity is greater than the steady acceleration velocity, the method 1400 proceeds to step 1430, where the system sends a command for steady acceleration up to cruise velocity.

FIG. 14C is a flow diagram of a steady acceleration control routine of the method 1400, in accordance with some embodiments. This steady acceleration control routine occurs int he event that the proportional controller velocity is greater than steady acceleration velocity in FIG. 14B. The method 1400 includes step 1432 where the system measures current torque and reads current motor velocity. Following step 1432, the method 1400 proceeds to step 1434 where the system computes an error value calculated as the difference between a target torque and a current torque. The method 1400 then moves to step 1436 where the system computes a proportional controller velocity command based on the computed error. After step 1436, the method 1400 proceeds to step 1438 where the system compares the proportional controller velocity to the current velocity. The purpose of this routine is to have a steady acceleration up to a cruise velocity initially, whereas the proportional controller alone would command a large initial jump, and then switch to proportional control as soon as the proportional controller wants to start slowing down. At step 1442, the system sends the proportional controller velocity command when appropriate.

FIG. 14D is a flow diagram of a first portion of a proportional control routine of the method 1400, in accordance with some embodiments. The method 1400 includes step 1444 where the system measures current torque. Following the measurement, the method 1400 proceeds to step 1446 where the system computes an error value calculated as the difference between the target torque and the current torque. The method 1400 then moves to step 1448 where a decision is made based on whether the error is less than zero. If the error is greater than zero, indicating that the current torque has not yet reached the target, the method 1400 proceeds to step 1450 where the system computes a proportional controller velocity command. If the error is less than or equal to zero, indicating that the target torque has been reached or exceeded, the method 1400 proceeds to step 1452 where the target is reached and the motor is stopped.

FIG. 14E is a flow diagram of a second portion of a velocity command saturation routine of the method 1400, in accordance with some embodiments. From step 1450 of FIG. 14D, the method 1400 proceeds to step 1454 where the process determines whether a proportional control command is above a minimum velocity. If the proportional control command is greater than the minimum velocity, the method 1400 proceeds to decision step 1460 that determines whether the proportional control command is above a maximum cruise velocity. This check may be necessary if the torque decreased significantly during the P Ctrl phase. If the proportional control command is not greater than the minimum velocity, the method 1400 proceeds to step 1458 where a minimum velocity command is sent, which corresponds to a lower saturation condition. From decision step 1460, if the proportional control command is above the maximum cruise velocity, the method 1400 proceeds to step 1464 where a cruise velocity command is sent as an upper saturation. If the proportional control command is below the maximum cruise velocity at step 1460, the method 1400 proceeds to step 1462 where a proportional control velocity command is sent.

FIG. 14F is a flow diagram of a final check state of the method 1400, in accordance with some embodiments. From connector E of FIG. 14E, the method proceeds to the final check state sub routine. During this subroutine, the method 1400 proceeds to step 1466, where the system takes multiple torque readings and averages them. Following step 1466, the method 1400 moves to step 1468, where the system determines whether the average torque is within tolerance of the target. At step 1468, the method 1400 branches based on the comparison result. If the average torque is below the target, the method 1400 proceeds to step 1470, where the system goes back to a proportional control state. If the average torque is within tolerance, the method 1400 proceeds to step 1474, which is a terminal state indicating that the torque has been reached and the system performs no further action. If the average torque is above the target, indicating an overshoot condition, the method 1400 proceeds to step 1472, which includes an annotation indicating that the system would decrease torque below the target by some amount as hysteresis compensation and then restart the controller.

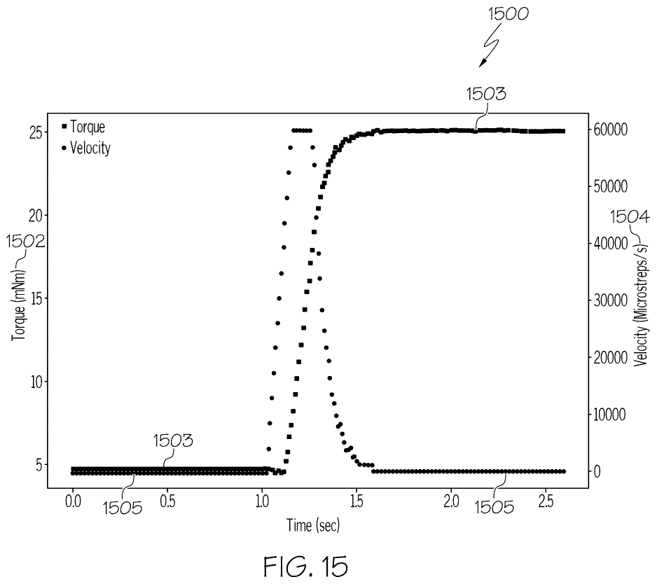

FIG. 15 is a graph of torque and velocity 1500 illustrating results of a torsion coupler torque controller for a thermal autosampler gripper apparatus, in accordance with some embodiments. The graph shows motor velocity and coupler measured torque versus time. The graph of torque and velocity 1500 includes a torque axis 1502 positioned on the left side, with torque values measured in millinewton-meters. A velocity axis 1504 is positioned on the right side, with exemplary velocity values measured in microsteps per second. A plot of torque 1503 and a plot of velocity 1505 are displayed against time. The torque data shows an initial relatively constant value followed by a rapid increase, with the rate of increase gradually decreasing as the torque approaches the target value. The velocity data shows an initial value near zero, followed by a sharp increase to a peak value, and then a gradual decrease back toward zero. The relationship between the torque and velocity data over time illustrates the operational characteristics of the thermal autosampler gripper apparatus during a gripping operation.

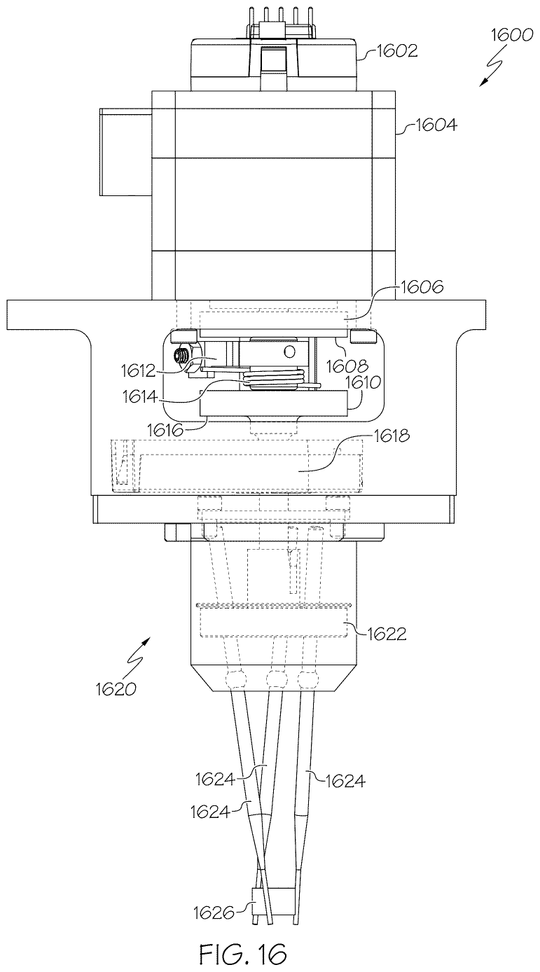

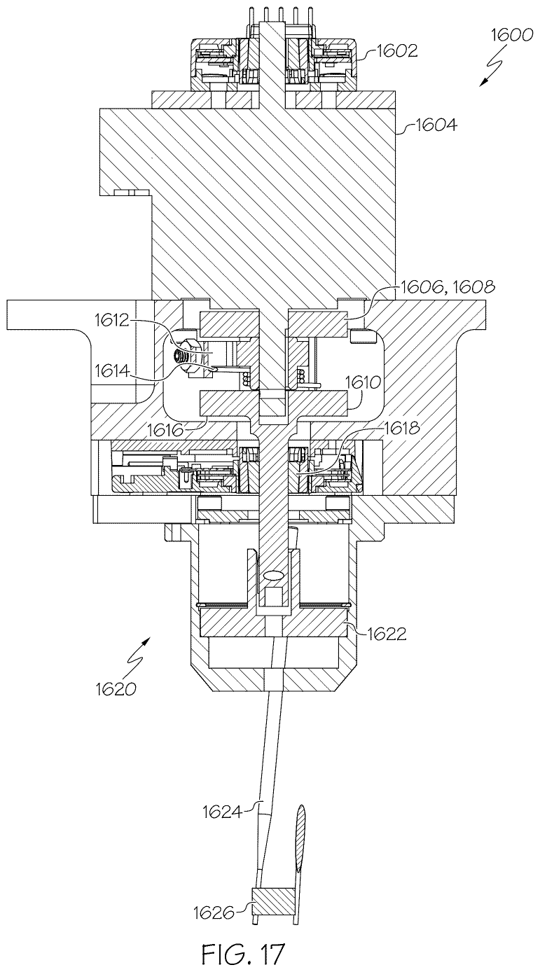

FIGS. 16 and 17 illustrate cross-sectional views of an autosampler gripper apparatus 1600 for an analytical instrument, in accordance with some embodiments. The autosampler gripper apparatus 1600 includes a motor encoder 1602 positioned at an upper portion of the assembly. A stepper motor 1604 is disposed below the motor encoder 1602. A key difference between the embodiment shown in FIGS. 16 and 17 and the embodiment shown in FIGS. 1A and 1B is the inclusion of additional bearing surfaces that support the coupler, motor output, and gripper. Specifically, the autosampler gripper apparatus 1600 includes a first upper bearing surface 1606, a second upper bearing surface 1608, and a lower bearing surface 1610. These bearing surfaces support the load of the system components. In the embodiment of FIGS. 1A and 1B, the gripper encoder was a larger device because it needed to include internal bearings to support the system. In the embodiment shown in FIGS. 16 and 17, the bearing surfaces 1606, 1608, 1610 support the load, allowing the gripper encoder 1618 to be a smaller and more cost effective device with no internal bearings. A coupler input member 1612 extends from the stepper motor 1604 and connects to a coil torsion spring 1614. The coil torsion spring 1614 is positioned between the coupler input member 1612 and a coupler output member 1616. The coupler output member 1616 is positioned at a lower region of the coupler assembly. The gripper encoder 1618 is positioned below the coupler output member 1616 and is arranged to determine an angular position of components below the coupler. A gripper output 1620 extends from the coupler output member 1616 and connects to a gripper rotor 1622. The gripper rotor 1622 drives gripper fingers 1624 positioned at a lower end of the apparatus. The gripper fingers 1624 are configured for grasping objects such as a pan 1626. The arrangement of the motor encoder 1602 above the coupler and the gripper encoder 1618 below the coupler enables measurement of coupler deflection, which allows for torque feedback and control during operation of the autosampler gripper apparatus 1600.

In summary, embodiments of the present inventive concept provide a torque control mechanism for a robotic end effector that addresses limitations associated with conventional stepper motor-driven gripper systems. By positioning a torsionally compliant coupler in the load path between a stepper motor and an end effector, and by employing two encoders to measure angular positions at the coupler input and output, the system may translate the stepper motor's positional control into fine torque control. The known relationship between coupler deflection and torque, characterized by the spring stiffness constant Kₛₚ, enables accurate torque estimation from encoder measurements without requiring dedicated torque sensors in the load chain.

The one-way hard stop feature of the coupler may provide several advantages. In some aspects, the hard stop allows for spring preload, which keeps the coupler input member and coupler output member locked together during position-controlled movements when no gripping torque is required. This arrangement may avoid oscillation about equilibrium that could otherwise occur when releasing gripped objects. In some cases, the hard stop enables reliable, smooth gripper opening even when friction is present in the load chain, as the rigid coupling through the engaged stop member permits the application of negative torque to overcome friction without requiring the spring to wind in the opposite direction.

The disclosed system may address the problem of grip force variability that arises in position-only control systems. In conventional systems, grip force depends on the overall stiffness of the load chain, and small errors in position due to object size variation or gripper geometry variation can result in large errors in grip force. The present inventive concept introduces a known compliance that decouples grip force from such variations, potentially improving grip security and reducing the risk of damage to gripped objects or the gripper mechanism.

In some embodiments, the system may eliminate the need for multiple calibrations when handling objects of different sizes, as torque-based control can adapt to varying object dimensions without requiring prior knowledge of appropriate gripper positions for each object type. The cost-effective actuation scheme provided by the combination of a stepper motor with the torsionally compliant coupler and dual encoders may offer simple, stable torque and position control suitable for thermal autosampler applications and other robotic end effector implementations.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A torque control mechanism for a robotic end effector of an analytical instrument autosampler, comprising:
a coupler input member configured to receive a motor shaft, the coupler input member including a stop member;
a coupler output member defining an interior region sized to receive the coupler input member, the coupler output member including at least one stop engagement protrusion extending into the interior region;
a torsion spring disposed between the coupler input member and the coupler output member, the torsion spring having a first end coupled to the coupler input member and a second end coupled to the coupler output member,
wherein the stop member and the at least one stop engagement protrusion are arranged to permit relative rotation between the coupler input member and the coupler output member in a first rotational direction corresponding to gripper closing while preventing relative rotation in a second rotational direction corresponding to gripper opening, and
wherein a controller is configured to determine a coupler deflection based on a difference between an angular position of the motor shaft and an angular position of a gripper mechanism coupled to the coupler output member, and to calculate an output torque applied to the gripper mechanism based on the coupler deflection and a torsional stiffness of the torsion spring.

2. The torque control mechanism of claim 1, further comprising:
a first encoder configured to measure the angular position of the motor shaft; and
a second encoder configured to measure the angular position of the gripper mechanism coupled to the coupler output member.

3. The torque control mechanism of claim 1, wherein the controller is configured to calculate the output torque according to a relationship where the output torque equals the torsional stiffness multiplied by the coupler deflection plus a preload torque value.

4. The torque control mechanism of claim 1, wherein the stop member comprises a tab extending from the coupler input member, and wherein the at least one stop engagement protrusion includes a preload adjustment screw configured to establish an initial angular position of the stop member relative to the coupler output member in a preload condition.

5. The torque control mechanism of claim 1, wherein in a preload condition the torsion spring biases the stop member into contact with the at least one stop engagement protrusion such that the coupler input member and the coupler output member rotate together as a unit.

6. The torque control mechanism of claim 1, wherein the controller is configured to operate in a position control mode when the stop member is engaged with the at least one stop engagement protrusion and to operate in a torque control mode when the stop member is disengaged from the at least one stop engagement protrusion.

7. The torque control mechanism of claim 1, wherein the arrangement of the stop member and the at least one stop engagement protrusion enables the controller to apply negative torque through the coupler output member to overcome friction in the gripper mechanism during gripper opening by rigid coupling through the engaged stop member.

8. The torque control mechanism of claim 1, wherein the torsion spring comprises a coil torsion spring having a near linear relationship between torque applied to the torsion spring and deflection of the torsion spring.

9. The torque control mechanism of claim 1, wherein the coupler input member includes two stop members extending in opposite directions from a cylindrical coupler input, and wherein the coupler output member includes two stop engagement protrusions extending into the interior region.

10. The torque control mechanism of claim 1, wherein the controller is configured to modulate the output torque by controlling an angular position of the motor shaft and using the coupler deflection as feedback to achieve a target torque value.

11. A method for position and torque control of an autosampler, comprising:
providing a torsionally compliant coupler in a load path between a stepper motor and a gripper mechanism, the coupler including a coupler input member coupled to the stepper motor, a coupler output member coupled to the gripper mechanism, a torsion spring disposed between the coupler input member and the coupler output member, and a stop member arranged to engage a stop engagement protrusion to provide a one-way hard stop;
measuring an angular position of the stepper motor;
measuring an angular position of the gripper mechanism;
operating in a position control mode when the stop member is engaged with the stop engagement protrusion, wherein the coupler input member and the coupler output member rotate together;
transitioning to a torque control mode when a gripping force causes the stop member to disengage from the stop engagement protrusion;
determining a coupler deflection from a difference between the angular position of the stepper motor and the angular position of the gripper mechanism; and
calculating an output torque applied to the gripper mechanism based on the coupler deflection and a torsional stiffness of the torsion spring.

12. The method of claim 11, wherein measuring the angular position of the stepper motor comprises measuring with a first encoder, and wherein measuring the angular position of the gripper mechanism comprises measuring with a second encoder.

13. The method of claim 11, further comprising:
applying a preload to the torsion spring such that the stop member is biased into contact with the stop engagement protrusion when no external load is applied to the gripper mechanism.

14. The method of claim 11, further comprising:
rotating the stepper motor in a gripper opening direction after gripping an object;
re-engaging the stop member with the stop engagement protrusion as the coupler deflection decreases; and
applying negative torque through the engaged stop member to overcome friction in the gripper mechanism and release the object.

15. The method of claim 11, wherein calculating the output torque comprises:
multiplying the coupler deflection by a spring stiffness constant of the torsion spring; and
adding a preload torque value to produce the output torque.

16. The method of claim 11, further comprising:
comparing the calculated output torque to a target torque value;
adjusting the angular position of the stepper motor based on the comparison; and
repeating the determining and calculating steps until the output torque reaches the target torque value.

17. The method of claim 11, further comprising:
detecting contact between gripper fingers of the gripper mechanism and an object based on a change in the coupler deflection while the stepper motor continues to rotate.

18. The method of claim 11, further comprising:
averaging a plurality of torque readings to determine a measured torque value; and
comparing the measured torque value to a threshold based on a preload value and a torque noise value.

19. The method of claim 11, further comprising:
commanding a steady acceleration of the stepper motor up to a cruise velocity during an initial phase of torque control; and
transitioning to proportional control when a proportional controller velocity command falls below a current velocity of the stepper motor.

20. The method of claim 11, further comprising:
verifying that the coupler is in the preload condition by commanding a test move in the gripper opening direction and measuring a torque change, wherein a torque change below a noise threshold indicates the preload condition.
